(19) United States
(12) Patent Application Publication
(10) Pub. No.: US 2012/0021766 A1
(43) Pub. Date: Jan. 26, 2012

(54) INFORMATION PROCESSING DEVICE AND DEVICE REGISTRATION METHOD

(75) Inventor: Masaya MASUDA, Fussa-shi (JP)

(73) Assignee: KABUSHIKI KAISHA TOSHIBA, Tokyo (JP)

(21) Appl. No.: 13/249,101

(22) Filed: Sep. 29, 2011

Related U.S. Application Data
(63) Continuation of application No. 12/847,852, filed on Jul. 30, 2010.

(30) Foreign Application Priority Data
Jul. 31, 2009 (JP) 2009-179527

(51) Int. Cl. H04W 24/00

(52) U.S. Cl. 455/456.1

(57) ABSTRACT

According to one embodiment, a storage module stores device information of a counterpart device generated by an authentication process required for wireless communication, a registration information control module registers location information as either of first location information of a location where the device information of the counterpart device will be stored after termination of wireless communication with the counterpart device and second location information of a location where the device information will not be stored after termination of the wireless communication, and a wireless communication control module receives location information of the wireless communication device at the time of execution of the wireless communication, determines whether the received location information coincides with the first location information or not, and executes an authentication process by use of the device information storied in the storage module to enable the wireless communication when the received location information coincides with the first location information.

### CROSS REFERENCE TO RELATED APPLICATION(S)

The present application is a continuation of U.S. application Ser. No. 12/847,852 filed on Jul. 30, 2010, which claims priority to Japanese Patent Application No. 2009-179527 filed on Jul. 31, 2009, each of which are incorporated herein by reference in their entireties.

### BACKGROUND

1. Field

One embodiment of the invention relates to an information processing device and a device registration method.

2. Description of the Related Art

A system for short-range wireless communication as represented by Bluetooth (registered trademark) has become popular in recent years due to an increasing demand for transmission/reception of information by wireless communication. For example, this type systems are a system in which audio data reproduced by a sound player is transmitted by wireless communication such as Bluetooth and listened to through wireless headphones, wireless speakers or the like, a hands-free system in which a cellular phone and a hands-free device are connected to each other by wireless, etc.

The short-range wireless communication represented by Bluetooth places its significant feature in that a device in question can be connected to other nearby devices by ad hoc communication in any use place instead of in a fixed place where the devices are used. On the other hand, it is general from the viewpoint of security that the devices are authenticated for connection. In addition, the configuration (called device registration operation) that information such as an address of a destination of connection and authentication information is held in a system for next and future connections after connection and authentication succeeded once becomes popular. For example, as represented by the mechanism of Secure Simple Pairing introduced at Version 2.1 of Bluetooth, the authentication operation between the devices has been improved so that the authentication operation can be executed by a simpler user's operation to make it possible for users to use ad hoc communication more simply and easily.

Generally in most cases, devices supporting short-range wireless communication as represented by Bluetooth are such embedded devices that system resources such as size of a storage region are often limited. For this reason, there has been performed a technique in which when a new device is to be registered beyond an upper limit of the number of devices allowed to be registered in a system, the oldest information in a registration sequence is deleted from already stored registration device information before the new device is registered (e.g. Japanese Patent Application Publication (KOKAI) No. 2008-65850).

Devices in home are usually registered and used in home on one hand, and devices carried by users are connected to one another and used or each device temporarily existing in an outdoor place is connected and used to utilize convenience of easy ad hoc communication on the other hand. Accordingly, if the oldest device information in a registration sequence is deleted according to the aforementioned technique, there is a possibility that device information registered for use in home will be deleted. It cannot be always said that the aforementioned technique performs control conformable to user's intension.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary schematic view showing conditions in use of a media player 1 according to an embodiment of the invention;

FIG. 2 is an exemplary functional block diagram of the media player according to this embodiment;

FIG. 3 is an exemplary conceptual view showing a state of storage of the registration location information in this embodiment;

FIG. 4 is an exemplary conceptual view showing a state of storage of the permanent device registration information in this embodiment;

FIG. 5 is an exemplary conceptual view showing a state of storage of the temporary device registration information in this embodiment;

FIG. 6 is an exemplary flow chart showing a procedure of pairing in a first embodiment of the invention;

FIG. 7 is an exemplary flow chart showing a procedure at the time of disconnection of Bluetooth communication in the first embodiment of the invention;

FIG. 8 is an exemplary flow chart showing a procedure of pairing in a second embodiment of the invention; and

FIG. 9 is an exemplary flow chart showing a procedure at the time of disconnection of Bluetooth communication in a third embodiment of the invention.

### DETAILED DESCRIPTION

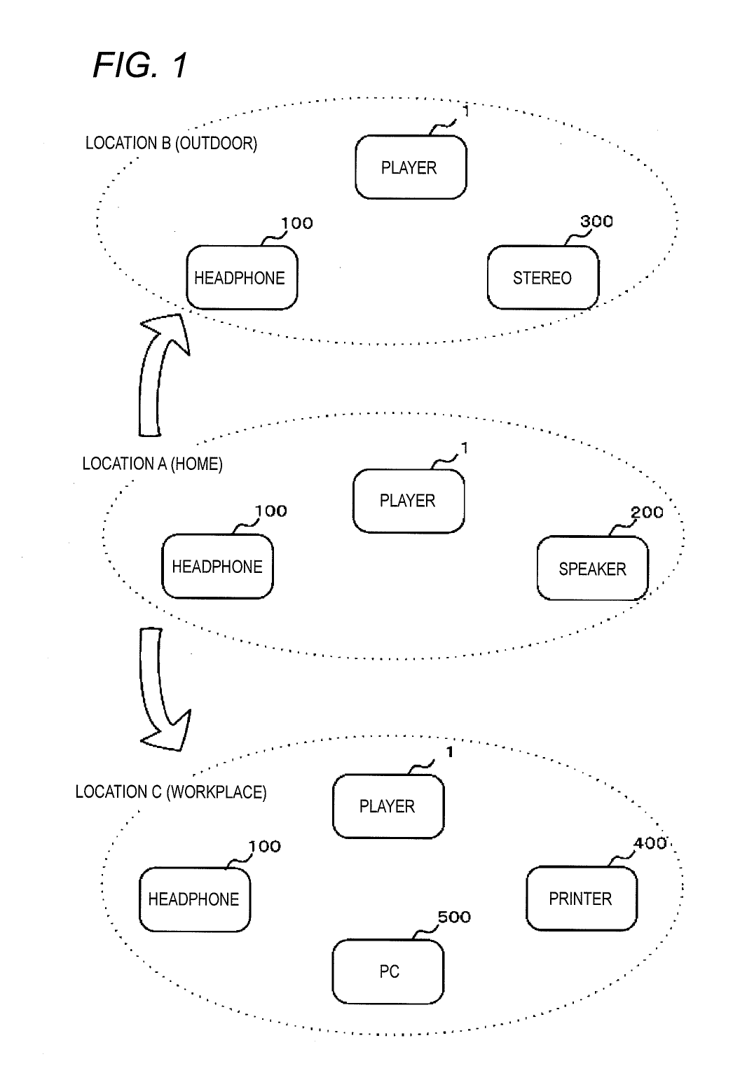

Various embodiments of the invention will be described below with reference to FIGS. 1 to 9.

Description will be made while a media player 1 is taken as an example of an electronic device according to the invention. Conditions in use of a wireless communication device according to the invention will be described first with reference to FIG. 1. FIG. 1 is a schematic view showing conditions in use of the media player 1 according to an embodiment of the invention.

In this embodiment, three locations, that is, location A (home), location B (outdoor) and location C (workplace) are assumed as locations where a user executes wireless communication. A speaker 200 is located in the location A. A stereo 300 is located in the location B. A printer 400 and a personal computer 500 are located in the location C. Under this situation, the user who carries the media player 1 and headphones 100 moves from the location A to the location B or C and performs wireless communication with a counterpart device in each location. For example, audio streaming data from the media player 1 is transmitted by wireless so as to be output from the speaker 200, the stereo 300 or the like, or video data from the media player 1 is transmitted by wireless so as to be output from the printer 400 or the personal computer 500. In this embodiment, wireless communication means communication based on the Bluetooth Standard (hereafter referred to as “Bluetooth communication”).

A pairing operation in the case where the media player 1 performs Bluetooth communication with a counterpart device (such as the speaker 200, the stereo 300, the printer 400 or the personal computer 500) will be described next. The pairing operation means a process executed by the media player 1 for authenticating and registering a device as a destination of wireless connection before execution of wireless communication. In this embodiment, the pairing operation is to execute an authentication and registration process defined by GAP (Generic Access Profile) of Bluetooth communication.

A flow of the pairing operation is as follows. First, devices each having a Bluetooth communication function and located in the periphery of the media player 1 are detected and a communication counterpart device of Bluetooth communication is selected from the detected devices. Then, a password called PIN (Personal Identification Number) code is input so that authentication is performed. When authentication succeeded once, an authenticated key is generated and stored together with an identifier of the communication counterpart device. Accordingly, when the media player 1 performs Bluetooth communication with the communication counterpart device again, inputting of the PIN code or the like is not required.

A flow up to the start of Bluetooth communication after the pairing operation will be described next. First, an instruction to execute Bluetooth communication is given from the media player 1 side or a communication counterpart device (the speaker 200, the stereo 300, the printer 400 or the personal computer 500) side or connection of Bluetooth communication is executed automatically without user's instruction. Then, a connection process is made by a method defined by AVRCP (Audio/Video Remote Control Profile), A2DP (Advanced Audio Distribution Profile), BIP (Basic Imaging Profile), OPP (Object Push Profile), SPP (Serial Port Profile) or the like of Bluetooth, so that data determined by each method can be transmitted/received in a two-way Bluetooth communication manner. For example, in the case of audio streaming transmission, the media player 1 and the headphones 100 are connected by a method defined by A2DP, so that coded streaming data is transmitted to the headphones 100. On the headphones 100 side, the received data is decoded by a decoding unit so as to be played back as audio. In this manner, audio data playback can be performed between the media player 1 and the headphones 100.

In this embodiment, the storage capacity of the media player 1 is so finite that the number of items such as identifiers and authenticated keys allowed to be stored in the media player 1 based on the pairing operation is limited. Accordingly, when the number of registered items has reached an upper limit, it is impossible to register device information of a new communication counterpart device if device information of any device is not deleted first. For example, information of a device to be deleted is selected from information of devices obtained by the oldest pairing operation or used least frequently. In this case, it is conceivable that the number of registered items in terms of device information in the media player 1 reaches an upper limit because the media player 1 performs Bluetooth communication with communication counterpart devices (the stereo 300, the printer 400 and the personal computer 500) located in the location B (outdoor) and the location C (workplace), or the media player 1 performs ad hoc Bluetooth communication with a large number of devices carried by other users. Consequently, device information of the speaker 200 located in the location A (home) may be deleted though the device information was registered before the media player 1 communicates with such a large number of devices in the location B (outdoor) and the location C (workplace). Accordingly, when the user goes back to the location A (home), the user must execute a pairing operation inclusive of inputting of a PIN code again to perform Bluetooth communication with the speaker 200. This requires much labor.

As described above, there is a user's demand for giving priorities to devices located in each location in accordance with the location where the media player 1 is used. That is, even when the number of registered items in the media player 1 has reached an upper limit, it is not appropriate to delete device information of devices assumed to be used permanently in home or the like. In this embodiment, therefore, location information is registered so that the location A (home) is regarded as a location where device information should be stored permanently while the locations B (outdoor) and C (workplace) are regarded as locations where device information should be stored temporarily. That is, device information of the headphones 100 and the speaker 200 pairing with the media player 1 in the location A is stored permanently in the media player 1. On the other hand, device information of the stereo 300, the printer 400 and the personal computer 500 pairing with the media player 1 in the locations B and C is stored temporarily in the media player 1 so that the device information can be deleted after disconnection of Bluetooth communication. In this manner, the way of storing device information is classified in accordance with the location so that device information of devices in a location where the user wants to use the media player 1 permanently can be prevented from being deleted.

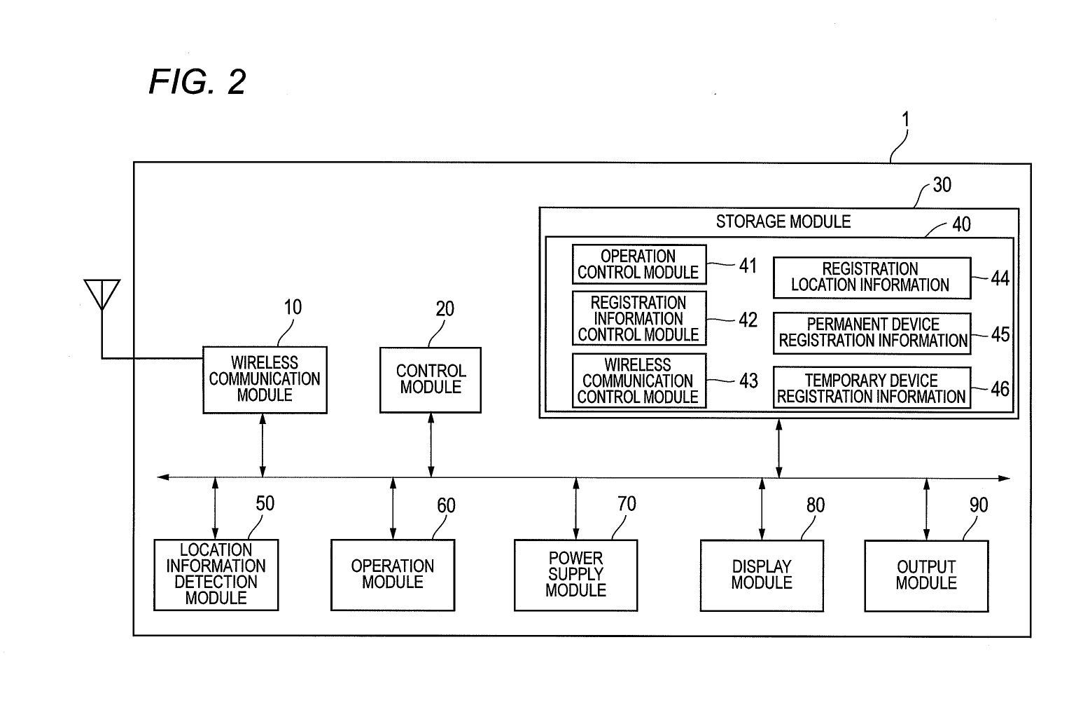

Functions of the media player 1 will be described next with reference to FIG. 2. FIG. 2 is a functional block diagram of the media player according to this embodiment.

The media player 1 has a wireless communication module 10, a control module 20, a storage module 30, a wireless communication application 40, a location information detection module 50, an operation module 60, a power supply module 70, a display module 80, and an output module 90.

The wireless communication module 10 is hardware which performs Bluetooth communication with an external communication device through an antenna.

The control module 20 is a processor which is provided for controlling the operation of the media player 1 and which executes various kinds of application programs stored in the storage module 30. For example, the wireless communication application 40 stored in the storage module 30 is executed based on an operation signal given from the operation module 60.

The storage module 30 is a storage unit which stores various kinds of application programs including an audio data playback application etc. The storage module 30 stores various kinds of data given from the outside and plays back the data in accordance with each playback application. In this embodiment, the wireless communication application 40 is stored in the storage module 30. The wireless communication application 40 will be described later.

The location information detection module 50 is hardware which detects location information of the media player 1. For example, a GPS (Global Positioning System) can be used as the location information detection module 50.

The operation module 60 receives an operation signal for the media player 1 in response to a user's operation and sends out the operation signal to the control module 20.

The power supply module 70 generates a system power supply from an external power supply or a battery provided in the media player 1 so that the generated system power supply can supply electric power to the media player 1.

The display module 80 displays the music name and play list of sound data currently played back and motion pictures corresponding to contents. For example, the display module 80 is a liquid crystal display.

The output module 90 is an interface which outputs various kinds of data to an external device such as a speaker so that the data can be played back by the external device.

The wireless communication application 40 has an operation control module 41, a registration information control module 42, a wireless communication control module 43, registration location information 44, permanent device registration information 45, and temporary device registration information 46.

The operation control module 41 controls operations of other functional modules such as the location information detection module 50 than the wireless communication application 40 based on an operation signal given from the operation module 60 when the wireless communication application 40 is executed.

The registration information control module 42 manages the registration location information 44, the permanent device registration information 45 and the temporary device registration information 46. For example, the registration information control module 42 determines whether an identifier of a communication counterpart device received from the wireless communication module 10 and an authenticated key generated by a pairing operation are to be stored in the permanent device registration information 45 or to be stored in the temporary device registration information 46. The registration information control module 42 further determines whether or not location information detected by the location information detection module 50 is to be stored as a location where device information should be stored permanently.

The wireless communication control module 43 controls the wireless communication module 10 to start or disconnect Bluetooth communication. The wireless communication control module 43 further receives an identifier peculiar to the communication counterpart device from the communication counterpart device when a pairing operation is executed.

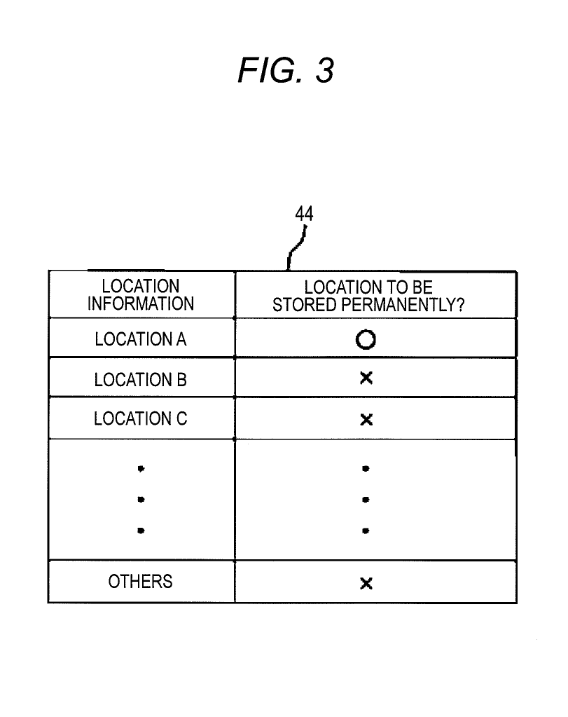

The registration location information 44 includes location information detected by the location information detection module 50, and a value stored in accordance with each location for determining whether device information is to be stored permanently or not. FIG. 3 is a conceptual view showing a state of storage of the registration location information in this embodiment. As shown in FIG. 3, location information detected by the location information detection module 50 is stored while associated with information as to whether device information of a device pairing with the media player 1 in this location is to be stored permanently or not. In the example shown in FIG. 3, setting is made so that device information of an external communication device pairing with the media player 1 in the “location A (home)” is stored permanently while device information of external communication devices pairing with the media player 1 in the “location B (outdoor)” and the “location C (workplace)” is stored temporarily. In addition, the item “others” indicates setting of location information in the case where a new location which has not been registered yet is detected. Setting as to whether device information of a device connected in each location is to be stored permanently or not, is made by the registration information control module 42 based on an operation signal given from the operation module 60.

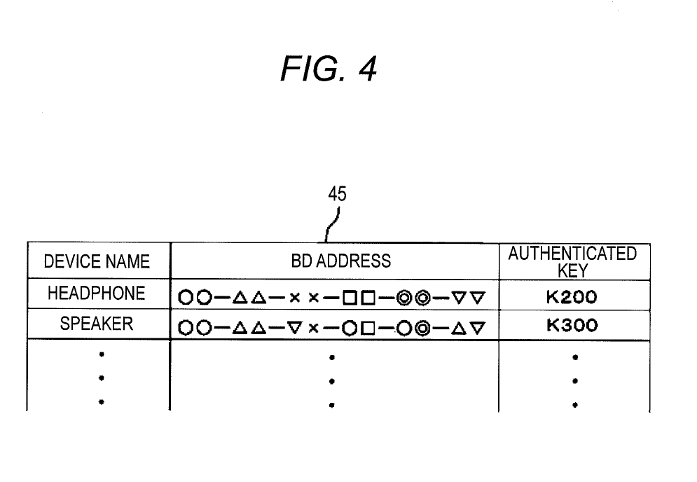

The permanent device registration information 45 is device information which is selected from all device information received from external communication devices and which is determined to be registered permanently by the registration information control module 42. FIG. 4 is a conceptual view showing a state of storage of the permanent device registration information in this embodiment. As shown in FIG. 4, a device name of each device, an identifier for identifying the device and an authenticated key for the device are stored while associated with one another. In this embodiment, for example, BD (Bluetooth Device) addresses allocated to devices each having a Bluetooth communication function are used as the identifiers for identifying devices respectively. The authenticated key means a key which is generated when the media player 1 executes an operation of pairing with each external communication device. The wireless communication control module 43 receives the location information from the location information detection module 50 at the time of execution of the wireless communication, determines whether the received location information coincides with the location information registered as a location where device information should be stored permanently in the registration location information 44 or not, and executes the authentication process by use of the device information stored in the permanent device registration information 45 to enable the wireless communication when the received location information coincides with the location information registered as a location where device information should be stored permanently in the registration location information 44.

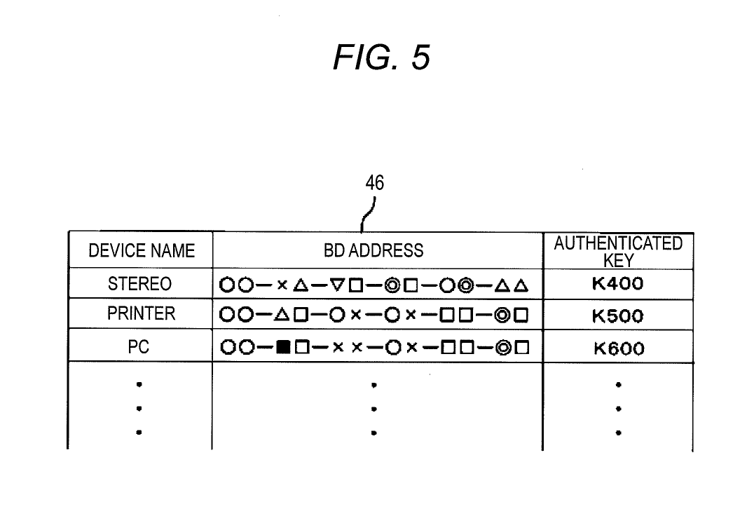

The temporary device registration information 46 is device information which is selected from all device information received from external communication devices and which is determined to be stored temporarily by the registration information control module 42. That is, location information stored in the temporary device registration information 46 is deleted when wireless communication is disconnected. FIG. 5 is a conceptual view showing a state of storage of the temporary device registration information in this embodiment. As shown in FIG. 5, a device name of each device, a BD address of the device and an authenticated key for the device are stored while associated with one another.

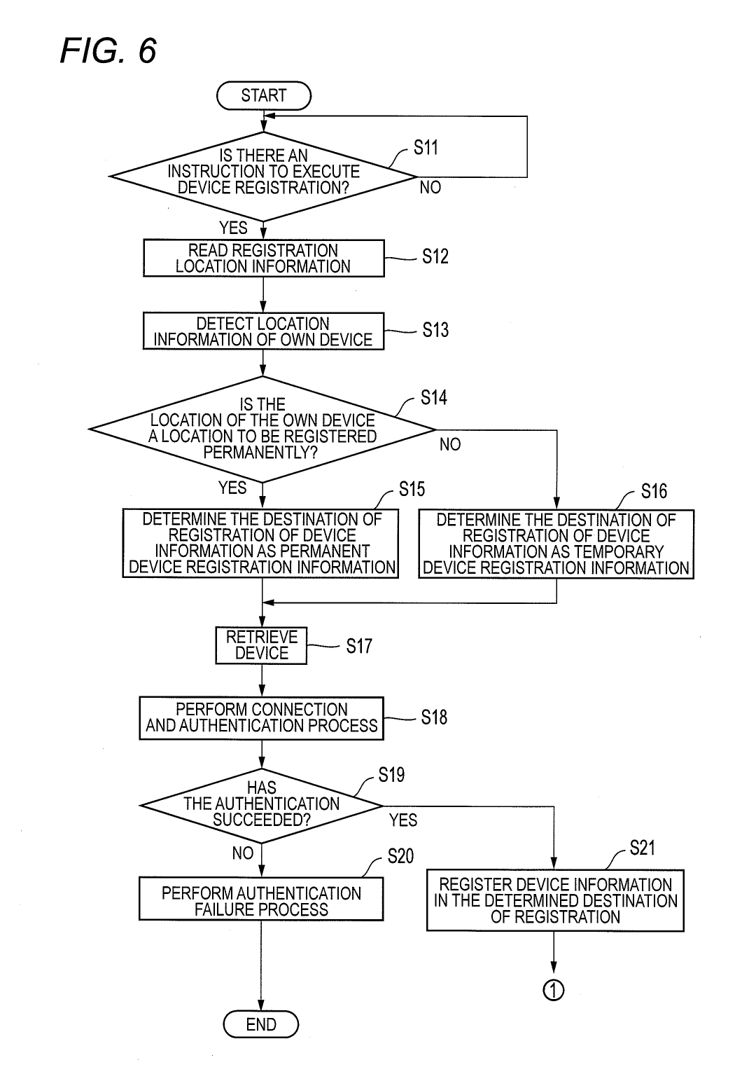

The pairing operation according to a first embodiment of the invention will be described next with reference to FIG. 6. FIG. 6 is a flow chart showing a procedure of pairing in the first embodiment of the invention.

First, the control module 20 determines whether an operation signal indicating execution of device registration is received from the operation module 60 or not (step S11). When the control module 20 consequently determines that the operation signal indicating execution of device registration is not received (No in step S11), the step S11 is repeated continuously unless determination is made that the operation signal is received. On the other hand, when the control module 20 consequently determines that the operation signal indicating execution of device registration is received (Yes in step S11), the control module 20 executes the wireless communication application 40 so that the registration information control module 42 reads the registration location information 44 (step S12).

Then, the operation control module 41 receives current location information of the media player 1 detected by the location information detection module 50 (step S13). Then, the operation control module 41 refers to the registration location information 44 read in the step S12 and the current location information received in the step S13 and determines whether or not the current location has been already registered as a location where device information should be stored permanently in the registration location information 44 (step S14).

When determination results in that the current location has been registered as a location where device information should be stored permanently in the registration location information 44 (Yes in step S14), the registration information control module 42 determines a destination of registration of device information as the permanent device registration information 45. On the other hand, when determination results in that the current location has not been registered as a location where device information should be stored permanently in the registration location information 44 (No in step S14), the registration information control module 42 determines a destination of registration of device information as the temporary device registration information 46.

By the aforementioned procedure, device registration is completed. Then, processing goes to a procedure for starting actual Bluetooth communication. That is, the wireless communication control module 43 retrieves devices located near enough to communicate with the wireless communication module 10 (step S17). In the case of Bluetooth communication, the wireless communication control module 43 sends out an inquiry packet by a method defined as an inquiry operation to thereby perform the retrieval, and receives a response packet to thereby detect communication counterpart device candidates.

Then, the wireless communication control module 43 receives an operation signal for selecting a communication counterpart device from the operation module 60 and a PIN code and executes a connection and authentication process (step S18). Then, the wireless communication control module 43 determines whether authentication has succeeded or failed (step S19). When the wireless communication control module 43 determines that authentication has failed (No in step S19), the wireless communication control module 43 executes an authentication failure process (step S20). For example, the authentication failure process means a process of disconnecting a lower-class wireless communication module connected in accordance with authentication. That is, the authentication failure process is to discontinue Bluetooth communication in the wireless communication module 10 and display a notice of failure in authentication on the display module 80. On the other hand, when determination results in that authentication has succeeded (Yes in step S19), device information is registered in the designation of registration determined in the step S15 or S16 (step S21). Then, the wireless communication control module 43 controls the wireless communication module 10 to start Bluetooth communication with the external communication device. Then, the subsequent procedure goes to step S31.

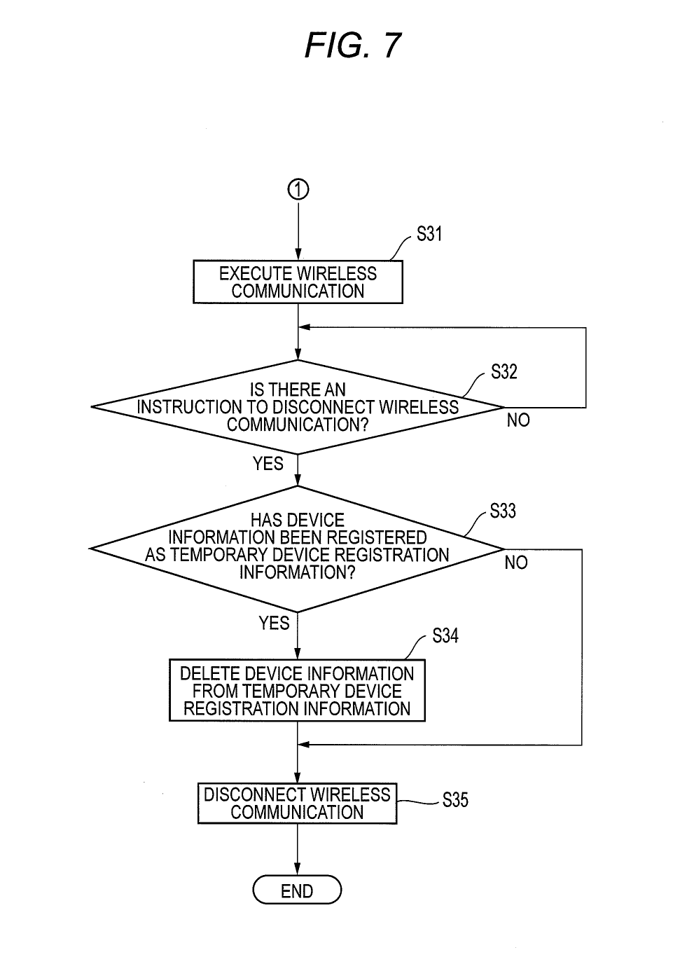

An operation of the media player 1 at the time of disconnection of Bluetooth communication will be described next with reference to FIG. 7. FIG. 7 is a flow chart showing a procedure at the time of disconnection of Bluetooth communication in the first embodiment of the invention.

First, the wireless communication module 10 of the media player 1 executes Bluetooth communication with an external communication device (step S31). Then, the wireless communication control module 43 determines whether an operation signal indicating disconnection of Bluetooth communication is received from either of the control module 60 and the communication counterpart device or not (step S32).

When determination results in that the operation signal indicating disconnection of Bluetooth communication is not received (No in step S32), the step S32 is repeated continuously unless determination is made that the operation signal is received. That is, Bluetooth communication continues. On the other hand, when determination results in that the operation signal indicating disconnection of Bluetooth communication is received (Yes in step S32), the registration information control module 42 then determines whether device information of the communication counterpart device under execution of Bluetooth communication has been registered in the temporary device registration information 46 or not (step S33).

When determination results in that the device information has not been registered in the temporary device registration information 46 (No in step S33), processing goes to step S35 which will be described later. On the other hand, when determination results in that the device information has been registered in the temporary device registration information 46 (Yes in step S33), the registration information control module 42 deletes the device information of the communication counterpart device from the temporary device registration information 46 (step S34).

Then, the wireless communication control module 43 disconnects Bluetooth communication executed by the wireless communication module 10 (step S35). By the aforementioned steps, the procedure of disconnecting wireless communication in the media player 1 is completed.

According to the first embodiment configured as described above, because device information of each Bluetooth communication counterpart device is stored while associated with a location where the media player 1 is used, unintended deletion of device registration information can be suppressed even when the number of registered items in terms of registration information has reached an upper limit.

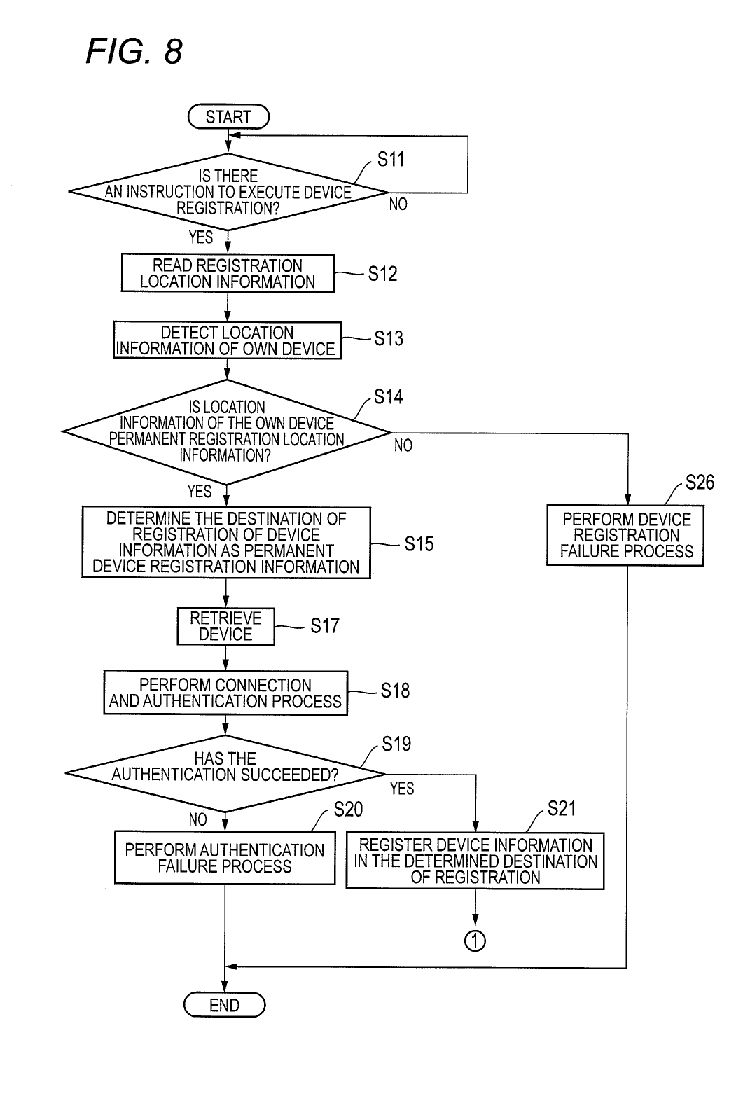

A second embodiment of the invention will be described next with reference to FIG. 8. In the second embodiment, Bluetooth communication cannot be executed in other locations than registered locations. FIG. 8 is a flow chart showing a procedure of pairing in the second embodiment of the invention.

In FIG. 8, steps the same as those in FIG. 6 are referred to by the same numerals and characters and description thereof will be omitted. In the second embodiment, when the operation control module 41 determines that the current location has not been registered as a location where device information should be stored permanently in the registration location information 44 (No in step S14), the wireless communication control module 43 executes a device registration failure operation (step S26). The device registration failure operation means that the wireless communication control module 43 controls the wireless communication module 10 not to execute Bluetooth communication and the operation control module 41 controls the display module 80 to display a notice of forbiddance of Bluetooth communication because the current location has not been registered. By the aforementioned steps, the procedure of the pairing operation according to the second embodiment is terminated.

According to the second embodiment configured as described above, because Bluetooth communication cannot be executed in other locations than locations registered by the user, device information of each Bluetooth communication counterpart device in non-registered locations is not stored. Accordingly, only device information of devices in registered locations is stored, so that mistaken deletion of device information of devices used permanently can be suppressed.

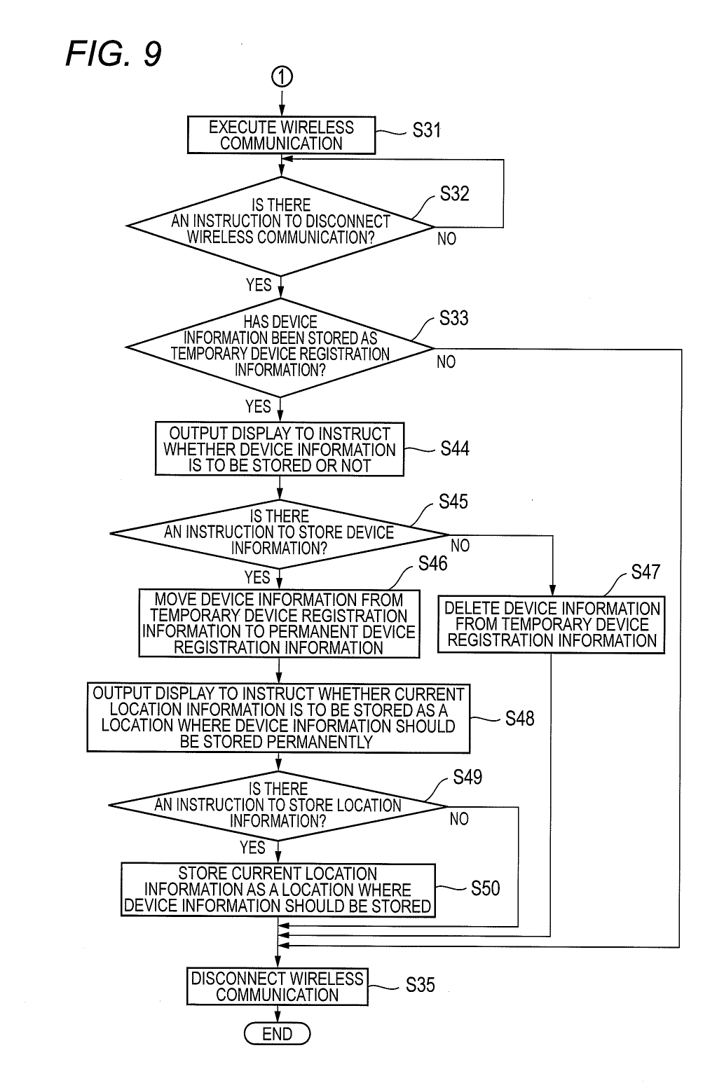

A third embodiment of the invention will be described next with reference to FIG. 9. In the third embodiment, when Bluetooth communication is to be started in other locations than registered locations, the user can be allowed to select whether device information of a communication counterpart device and location information thereof are to be stored in the permanent device registration information 45 or not. FIG. 9 is a flow chart showing a procedure at the time of disconnection of Bluetooth communication in the third embodiment of the invention.

In FIG. 9, steps the same as those in FIG. 7 are referred to by the same numerals and characters and description thereof will be omitted. In the third embodiment, when the registration information control module 42 determines that device information of a communication counterpart device under execution of Bluetooth communication has been registered in the temporary device registration information 46 (Yes in step S33), the operation control module 41 outputs a display for an instruction as to whether device information of the communication counterpart device is to be stored or not, to the display module 80 (step S44). Then, the registration information control module 42 determines whether an instruction to store device information of the communication counterpart device is given or not (step S45).

When the registration information control module 42 determines that an instruction to store device information is given (Yes in step S45), the registration information control module 42 moves the device information from the temporary device registration information 46 to the permanent device registration information 45 to store the device information (step S46). On the other hand, when the registration information control module 42 determines that an instruction to store device information is not given (No in step S45), the registration information control module 42 deletes the device information from the temporary device registration information 46 (step S47).

Then, the operation control module 41 outputs a display for an instruction as to whether or not the current location information detected by the location information detection module 50 is to be registered as a location where device information should be stored permanently in the registration location information 44, to the display module 80 (step S48).

Then, determination is made as to whether an instruction to register the current location information as a location where device information should be stored permanently in the registration location information 44 is given or not (step S49). When determination results in that an instruction to register the current location information as a location where device information should be stored permanently is not given (No in step S49), processing goes to the step S35. That is, Bluetooth communication is disconnected without registration of location information in the registration location information 44.

On the other hand, when determination results in that an instruction to register the current location information as a location where device information should be stored permanently is given (Yes in step S49), the registration information control module 42 registers the current location information as a location where device information should be stored permanently in the registration location information 44 (step S50). Then, processing goes to the step S35.

According to the third embodiment configured as described above, because the user per se can decide whether device information and location information should be stored permanently or not, user-friendliness of the media player 1 is improved.

Incidentally, the invention is not limited to the aforementioned embodiment per se and constituent members may be changed or modified for embodying the invention without departing from the gist of the invention in a practical stage. Constituent members disclosed in the aforementioned embodiment may be combined suitably to form various inventions. For example, some of all constituent members disclosed in the embodiment may be removed. In addition, constituent members disclosed in different embodiments may be combined suitably.

1. A wireless communication device using an authentication process for wireless communication, comprising:
a wireless communication module configured to communicate with a counterpart device by wireless communication;
a location detection module configured to receive location information of the wireless communication device;
a storage module configured to store device information of the counterpart device generated by the authentication process, wherein the storage module comprises:
a first storage module configured to store the device information of the counterpart device if the received location information corresponds to a location to be stored for a first time period; and
a second storage module configured to store the device information of the counterpart device if the received location information corresponds to a location that is not to be stored for the first time period;
a registration information controller configured to register the location information received by the location detection module as either first location information of a location where the device information is stored for the first time period after termination of the wireless communication or second location information of a location where the device information is not stored for the first time period after termination of the wireless communication; and
a wireless communication controller configured to receive the location information of the wireless communication device at the time of the wireless communication, to determine whether the received location information corresponds with the first location information, and to execute the authentication process based on the device information stored in the first storage module in order to enable the wireless communication if the received location information corresponds with the first location information,
wherein the registration information controller is configured to delete the device information in the second storage module at the time of termination of the wireless communication in the wireless communication module.

2. (canceled)

3. The device of claim 1, wherein the wireless communication module is configured to disable the wireless communication if the received location information at the time of the wireless communication is the second location information.

4. The device of claim 1,
wherein the storage module comprises:
a first storage module configured to store the device information of the counterpart device as a destination of the wireless communication executed by the wireless communication module when the received location information at the time of the wireless communication is the first location information; and
a second storage module configured to store the device information of the counterpart device as a destination of the wireless communication executed by the wireless communication module when the received location information at the time of the wireless communication is the second location information,
wherein the wireless communication device further comprises an operation module configured to send an operation signal to the registration information controller, and
wherein the registration information controller is configured to move the device information from the second storage module to the first storage module in order to store the device information permanently, if the received location information at the time of the wireless communication is the second location information and the operation signal instructs to store the device information of the counterpart device as a destination of the wireless communication permanently.

5. The device of claim 4, wherein the registration information control module is configured to store the received location information at the time of the wireless communication as the first location information if the received location information at the time of the wireless communication is the second location information or newly detected location information corresponding with neither the first location information nor the second location information and the operation signal indicates to set the received location information at the time of the wireless communication as the first location information.

6. A device registration method in a wireless communication device performing a wireless communication using an authentication process, comprising:
wirelessly communicating with a counterpart device;
receiving location information indicating a location of the wireless communication device;
storing device information of the counterpart device generated by the authentication process in a first storage module if the received location information corresponds to a location to be stored for a first time period;
storing device information of the counterpart device generated by the authentication process in a second storage module if the received location information corresponds to a location that is not to be stored for the first time period;
registering the location information as either first location information where the device information is stored for the first time period after termination of the wireless communication or second location information where the device information is not stored for the first time period after termination of the wireless communication;
determining whether third location information being location information of the wireless communication device at the time of the wireless communication is the first location information;
executing the authentication process based on the device information stored in the first storage module in order to enable the wireless communication if the received location information is the first location information; and
deleting the device information in the second storage module when the wireless communication is terminated.

7. (canceled)

8. The method of claim 6 further comprising:
storing the device information of the counterpart device as a destination of wireless communication by a wireless communication module if the location information at the time of the wireless communication is the first location information; and
disabling the wireless communication by the wireless communication module if the received location information at the time of the wireless communication is the second location information.

9. The method of claim 6 further comprising:
storing the device information of the counterpart device as a destination of wireless communication in a first storage module if the received location information at the time of the wireless communication is the first location information;
storing the device information of the counterpart device as a destination of wireless communication in a second storage module if the received location information at the time of the wireless communication is the second location information;
inquiring about selection as to whether the device information is to be stored permanently, if the received location information at the time of the wireless communication is the second location information; and
moving the device information from the second storage module to the first storage module in order to store the device information permanently if the selection result is that the device information is to be stored permanently.

10. The method of claim 9 further comprising:
inquiring about selection as to whether the received location information at the time of the wireless communication is to be registered as the first location information, if the received location information at the time of the wireless communication is the second location information or newly detected location information corresponding with neither the first location information nor the second location information; and
registering the received location information at the time of the wireless communication as the first location information when the selection result is that the received location information at the time of the wireless communication is to be registered as the first location information.
